(19) United States
(12) Patent Application Publication
(10) Pub. No.: US 2018/0339419 A1
(43) Pub. Date: Nov. 29, 2018

(54) ARBOR FOR A SAW BLADE

(71) Applicant: MILWAUKEE ELECTRIC TOOL CORPORATION, Brookfield, WI (US)

(72) Inventor: Edward Landon, Slinger, WI (US)

(21) Appl. No.: 15/987,254

(22) Filed: May 23, 2018

Related U.S. Application Data
(60) Provisional application No. 62/510,582, filed on May 24, 2017.

(51) Int. Cl. B27B 5/32; B23D 61/02

(52) U.S. Cl. CPC B27B 5/32; B28D 1/04; B23D 61/025

(57) ABSTRACT

A saw blade for use on a saw includes a front face, a rear face opposite the front face, and an outer periphery edge between the front face and the rear face. The saw blade also includes a cutting edge located on the outer periphery edge and an arbor located at a center of the saw blade. The arbor includes an arbor body, a central bore formed through the arbor body, and an aperture formed through the front face and the rear face at a perimeter of the arbor body. The aperture is spaced apart from the central bore such that a portion of the arbor body extends between the central bore and the aperture. The aperture is configured to receive a tool to facilitate removing the arbor body from the saw blade.

### CROSS REFERENCE TO RELATED APPLICATIONS

This application claims priority to U.S. Provisional Patent Application No. 62/510,582, filed May 24, 2017, the entire contents of which are incorporated herein by reference.

### BACKGROUND

The present invention relates to saw blades, and in particular, saw blades having removable arbors.

Some power tools use circular saw blades to cut a variety of materials. These power tools generally have a motor that rotates the saw blade on an output shaft. The output shaft can have a circular cross section, as is typical for most power tools using a circular saw blade, or a generally diamond shaped cross section, as is typical in worm gear drive power tools. A saw blade for use with these power tools generally has an opening in the center that is configured to fit on the output shaft of the power tool and rotate with the rotation of the shaft so that the power tool can perform a cutting operation.

Circular saw blades that can be used on power tools having either a circular shaft or a diamond shaped shaft typically include a generally diamond shaped arbor in the center of the saw blade. The arbor has a generally circular opening in the center that enables the saw blade to be used on power tools with circular output shafts. The arbor can be detached from the saw blade, leaving a central opening in the saw blade that is diamond shaped. The diamond shaped arbor permits the saw blade to be used with power tools with a diamond shaped output shaft.

### SUMMARY

In one embodiment, the invention provides a saw blade for use on a saw. The saw blade includes a front face, a rear face opposite the front face, and an outer periphery edge between the front face and the rear face. The saw blade also includes a cutting edge located on the outer periphery edge and an arbor located at a center of the saw blade. The arbor includes an arbor body, a central bore formed through the arbor body, and an aperture formed through the front face and the rear face at a perimeter of the arbor body. The aperture is spaced apart from the central bore such that a portion of the arbor body extends between the central bore and the aperture. The aperture is configured to receive a tool to facilitate removing the arbor body from the saw blade.

In another embodiment, the invention provides a saw blade for use on a saw. The saw blade includes a front face, a rear face opposite the front face, an outer periphery edge between the front face and the rear face, a cutting edge located on the outer periphery edge, and an arbor located at a center of the saw blade. The arbor includes an arbor body, a central bore formed through the arbor body, and an aperture formed through the arbor body and separate from the central bore. The aperture is configured to receive a tool to facilitate removing the arbor from the saw blade.

In another embodiment, the invention provides a method of removing an arbor from a saw blade. The arbor includes an arbor body, a central bore formed through the arbor body, and an aperture formed through the arbor body and separate from the central body. The method includes inserting a tool into the aperture, pivoting the tool inside the aperture to at least partially separate the arbor body from the saw blade, lifting the tool away from the saw blade to at least partially separate the arbor body from the saw blade, removing the arbor body from the saw blade after the arbor body is sufficiently separated.

Other aspects of the invention will become apparent by consideration of the detailed description and accompanying drawings.

### BRIEF DESCRIPTION OF THE DRAWINGS

FIG. 1 is a side view of a saw blade, the saw blade including an arbor.

FIG. 2 is an enlarged view of the arbor.

FIGS. 3-6 illustrate a method of removing the arbor from the saw blade by using a tool.

FIG. 7 is a flowchart depicting the method of removing the arbor from the saw blade.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

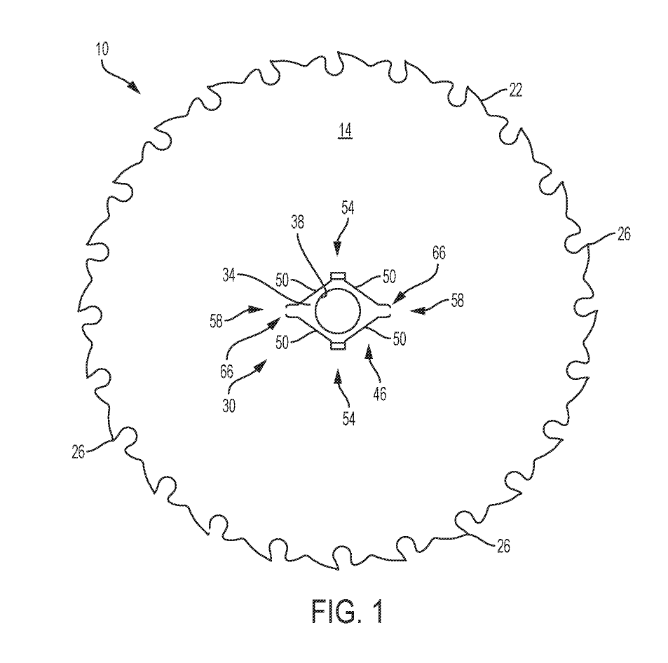

With reference to FIG. 1, a saw blade 10 is shown for cutting or edging a workpiece. The saw blade 10 has a front face 14, a rear face 18 (FIG. 6), and an outer periphery edge 22 that extends between the front face 14 and the rear face 18 and defines the thickness of the saw blade 10. The outer periphery edge 22 is generally circular and extends around the full circumference of the saw blade 10. In the illustrated embodiment, the outer periphery edge 22 defines a cutting edge that includes a plurality of teeth 26 that are spaced along the outer periphery edge 22. Alternatively, instead of having a plurality of teeth 26, the outer periphery edge 22 can be a cutting edge made from an abrasive cutting material (e.g., grit, carbide, or the like) which can be used for cutting bricks, tile, and other similar surface types.

The saw blade 10 can be made from a variety of materials. In some embodiments, the saw blade 10 is made from high carbon steel. In other embodiments, the saw blade 10 may be a bi-metal saw blade where the teeth 26 are formed from high speed steel that is bonded to the remainder of the saw blade. In still other embodiments, the saw blade 10 may include carbide cutting teeth. In further embodiments, the saw blade 10 can be made from a variety of materials, such as when the saw blade is a masonry blade.

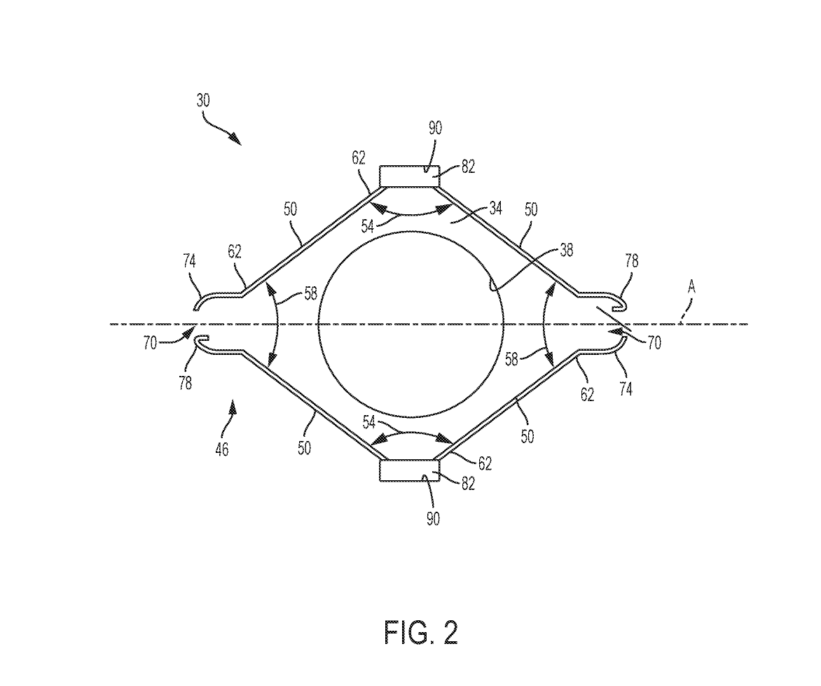

With reference to FIGS. 1 and 2, the saw blade 10 also includes an arbor 30 that is located at the center of the saw blade 10. The illustrated arbor 30 is generally diamond shaped and includes an arbor body 34 and a generally circular central bore 38. The central bore 38 is configured to allow the saw blade 10 to fit on a power tool, such as a circular saw, having a circular shaft. Etchings 46, or score lines, are formed in the saw blade 10 to outline the arbor body 34. In other words, the etchings 46 at least partially define a perimeter of the arbor body 34. In some embodiments, a laser is used to cut the etchings 46 on the saw blade 10. In the illustrated embodiment, the etchings 46 extend through the saw blade 10 from the front face 14 to the rear face 18 (FIG. 6). In other embodiments, the etchings 46 may be recesses formed in the front face 14, the rear face 18, or both that do not extend entirely through the saw blade 10. In the illustrated embodiment, the etchings 46 outline the arbor body 34 into a generally diamond shape. In other embodiments, the etchings 46 can outline the arbor body 34 into other shapes such as squares, triangles, rectangles, etc. Alternatively, instead of having the arbor body 34 formed by a laser, other forms of cutting can be used to outline the arbor body 34 (e.g., stamping, water jet, plasma, milling, and the like).

With continued reference to FIG. 2, the arbor body 34 is outlined by four laser etched extensions 50 that surround the central bore 38 and generally define the diamond shape of the arbor body 34. The extensions 50 form two obtuse angles 54 on opposing sides of the central bore 58, and two acute angles 58 on opposing sides of the central bore 38. Ends 62 of the extensions 50 proximate the acute angles 58 of the arbor body 34 include laser etched hooks 66 that continue from the laser etched extensions 50 and away from the central bore 38. In between the hooks 66 are uninterrupted portions 70 of the arbor body 34 that do not include etchings. In the illustrated embodiment, an open hook 74 and a closed hook 78 are located at each of the acute angles 58 of the arbor body 34. In other embodiments, the hooks 66 can be any combination of open hooks 74 or closed hooks 78. In further embodiments, the arbor body 34 does not have hooks 66 laser etched at the ends 62 of the extensions 50. In addition, in some embodiments, the material of the saw blade 10 and the material of the arbor 30 may be different.

The arbor 30 also includes at least one aperture 82. The illustrated apertures 82 are located at ends 62 of the extensions 50 proximate the obtuse angles 54. The illustrated apertures 82 are also formed at the perimeter of the arbor body 34. The apertures 82 are spaced apart from the central bore 58 such that a portion of the arbor body 34 extends between the central bore 58 and the aperture 82. In the illustrated embodiment, the arbor 30 includes two apertures 82. In other embodiments, the arbor 30 may include fewer or more apertures 82. The apertures 82 extend from the front face 14 of the saw blade 10 to the rear face 18 and have an inside edge 90 extending between the front face 14 and the rear face 18. In the illustrated embodiment, the apertures 82 are tangent to the ends 62 of the extensions 50 proximate the obtuse angle 54. The illustrated apertures 82 are fully contained, or bounded, by the saw blade 10 and do not extend into or communicate with the central opening 38. Additionally, in the illustrated embodiment, the apertures 82 have a generally rectangular shape. In other embodiments, the apertures 82 can be any shape such as square, triangle, oval, circle, hexagonal, and the like.

The apertures 82 are located an equidistance from a pivot axis A that extends through the uninterrupted portions 70 and the center of the saw blade 10. As such, the arbor 30 is mirror-symmetric about the pivot axis A, meaning that the arbor 30 would appear the same if rotated 180 degrees around the center of the saw blade 10. The apertures 82 are also located equidistant from the uninterrupted portions 70. In other words, the apertures 82 are the same distance from each of the uninterrupted portions 70 to where the apertures 82 are tangent with the extensions 50.

The arbor 30 is configured to be selectively removed from the saw blade 10 to create a generally diamond shaped opening in the saw blade 10. The diamond shaped opening is configured to allow the saw blade 10 to fit on a power tool that is, for example, worm driven and has a generally diamond shaped shaft. The laser etchings 46 and the apertures 82 are designed to facilitate removing the arbor 30 from the saw blade 10

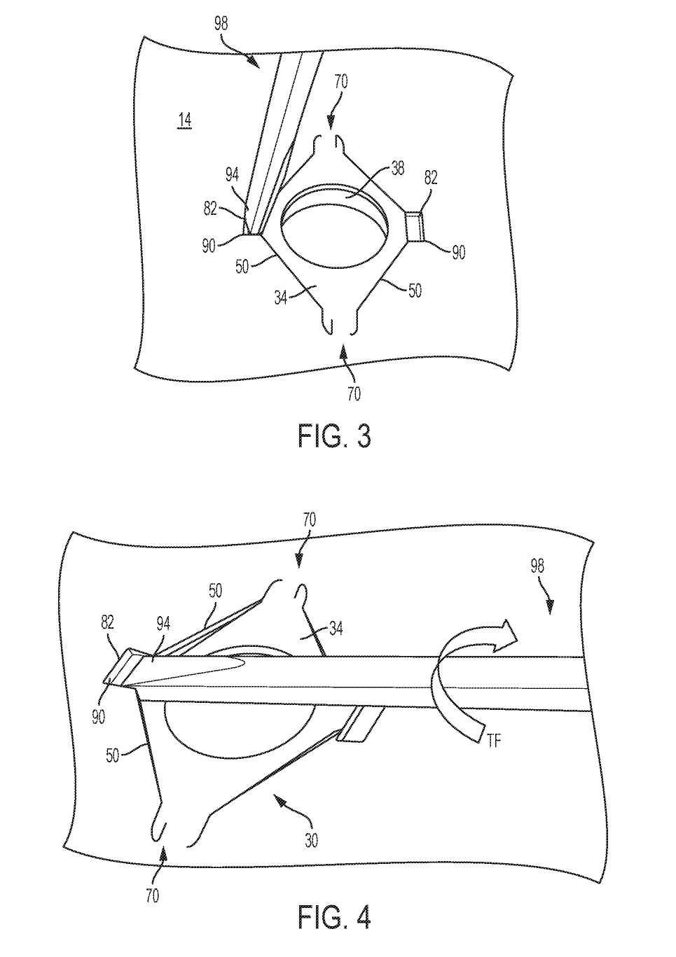

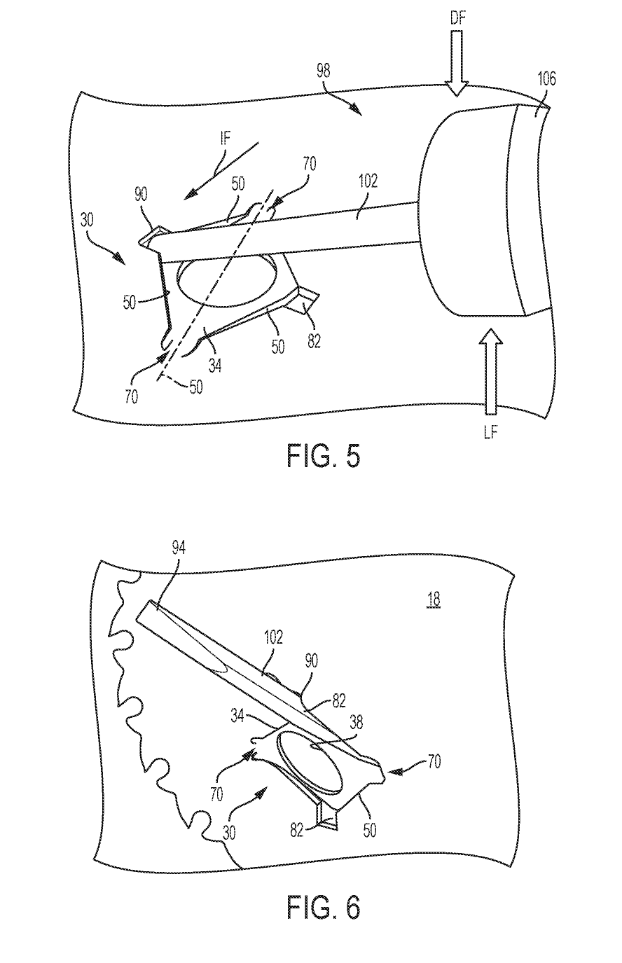

With reference to FIGS. 3-6, the apertures 82 are sized to receive a head 94 of a tool 98, such as a flat head screwdriver, a pliers, an Allen wrench, or any other tool where at least a portion can be inserted into the apertures 82. To remove the arbor 30, a user inserts the head 94 of the tool 98 into one of the apertures 82, as shown in FIG. 3. Once the head 94 of the tool 98 is within the aperture 82, a user applies a slight pivoting force, as indicated by arrow TF, to the tool 98 so that the head 94 of the tool 98 engages the inside edge 90 of the aperture 82, applying a force that begins to separate the arbor 30 from the saw blade 10 (FIG. 4). At the same time, a user also applies an inward force, as indicated by the arrow IF, towards the front face 14 of the saw blade 10 (FIG. 5). Upon separation, the laser cut extensions 50 begin to break-away from the saw blade 10, leaving only the uninterrupted sections 70 of the arbor body 34 attached to the saw blade 10. The combination of the pivoting force TF on the inner edge 90 of the aperture 82 and the inward force IF allows a shank 102 of the tool 98 to slide through the aperture 82 and rest on the inside edge 90 (FIG. 6).

With the shank 102 of the tool extending through the aperture 82, the user applies a lifting force, as indicated by arrow LF, to a handle 106 of the tool 98, using the shank 102 on the inside edge 90 as a fulcrum and causing the arbor 30 to begin rotating about the pivot axis A (FIG. 5). The lifting force LF rotates the arbor 30 and begins to weaken the attachment at the uninterrupted sections 70 to the saw blade 10. The lifting force LF continues to be applied until either the arbor 30 completely separates or the handle 106 of the tool 98 touches the front face 14. If the arbor 30 does not completely separate from the saw blade 10 by the lifting force LF, a user may apply a downward force, as indicated by arrow DF, to the handle 106 of the tool 98 (FIG. 5). If the arbor 30 still has not completely separated from the saw blade 10, a user may rotate between applying the lifting force LF and the downward force DF to the handle 106 of the tool 98 until the arbor 30 has completely separated from the saw blade 10.

After the arbor 30 is removed from the saw blade 10, a generally diamond shaped opening is left in the saw blade 10 to fit on a power tool that has a diamond shaped shaft.

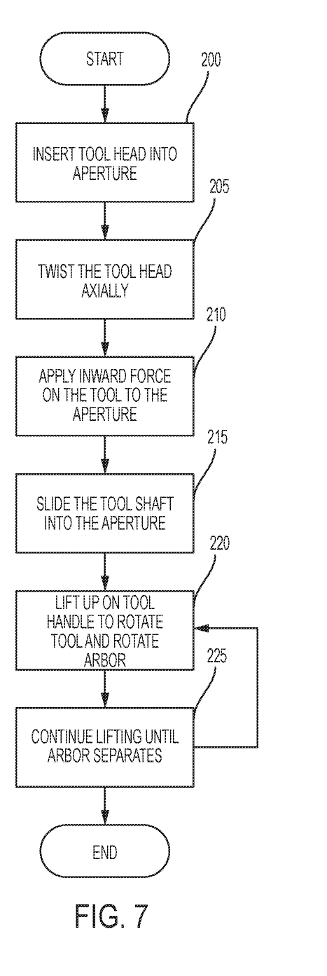

FIG. 7 is a flow chart depicting the method described above with reference to FIGS. 3-6. In particular, the method begins by inserting the tool head 94 into one of the apertures 82 (step 200). The tool head 94 is then pivoted, as indicated by arrow TF, inside one of the apertures 82 (step 205) to at least partially separate the arbor body 34 from the saw blade 10. As the tool head 94 is pivoted, an inward force IF is applied with the tool 98 to the aperture 82 (step 210). The pivoting force and the inward force allow the tool shaft 98 to be slid further into the aperture 82 (step 215). The method then includes lifting the tool handle 106 to rotate the tool 98 and the arbor 30 to at least partially separate the arbor body 34 from the saw blade 10 (step 220). The last step of the method is to continue applying the lifting force until the arbor body 34 is able to be removed from the saw blade 10 (step 225). It should be noted that the steps do not have to occur in this particular order and some steps may occur in a different order (e.g., a user can apply an inward force before pivoting the tool head). It should also be noted that the method may occur without some of the steps identified and achieve the same result.

In some embodiments, the arbor 30 is configured to be selectively inserted back into the diamond shaped opening so a user can switch the saw blade 10 between saws with circular and diamond shafts.

Various features and advantages of the invention are set forth in the following claims.

What is claimed is:

1. A saw blade for use on a saw, the saw blade comprising:
a front face;
a rear face opposite the front face;
an outer periphery edge between the front face and the rear face;
a cutting edge located on the outer periphery edge; and
an arbor located at a center of the saw blade, the arbor including an arbor body, a central bore formed through the arbor body, and an aperture formed through the front face and the rear face at a perimeter of the arbor body,
wherein the aperture is spaced apart from the central bore such that a portion of the arbor body extends between the central bore and the aperture, and wherein the aperture is configured to receive a tool to facilitate removing the arbor body from the saw blade.

2. The saw blade of claim 1, wherein the arbor body is diamond shaped.

3. The saw blade of claim 1, wherein the perimeter of the arbor body is partially defined by etchings.

4. The saw blade of claim 3, wherein the etchings are formed through the front face and the rear face.

5. The saw blade of claim 3, wherein the etchings include extensions forming obtuse angles on opposite sides of the central bore and acute angels on opposite sides of the central bore.

6. The saw blade of claim 1, wherein the aperture is a first aperture, wherein the arbor further includes a second aperture formed through the front face and the rear face at the perimeter of the arbor body, wherein the second aperture is spaced apart from the central bore such that a portion of the arbor body extends between the central bore and the second aperture, and wherein the second aperture is configured to receive a tool to facilitate removing the arbor body from the saw blade.

7. The saw blade of claim 6, wherein the perimeter of the arbor body is also partially defined by etchings connected to the first aperture and the second aperture, and wherein the arbor body includes uninterrupted portions between ends of the etchings that connect the arbor body to the saw blade.

8. The saw blade of claim 7, wherein a pivot axis extends through the uninterrupted portions and the central bore, and wherein the first aperture and the second aperture are positioned on opposites sides of the pivot axis at equidistance from the pivot axis.

9. The saw blade of claim 8, wherein the arbor is mirror-symmetric about the pivot axis.

10. A saw blade for use on a saw, the saw blade comprising:
a front face;
a rear face opposite the front face;
an outer periphery edge between the front face and the rear face;
a cutting edge located on the outer periphery edge; and
an arbor located at a center of the saw blade, the arbor including
an arbor body,
a central bore formed through the arbor body, and
an aperture formed through the arbor body and separate from the central bore, the aperture configured to receive a tool to facilitate removing the arbor body from the saw blade.

11. The saw blade of claim 10, wherein the aperture is a first aperture, wherein the arbor further includes a second aperture formed through the arbor body and separate from the central bore and the first aperture, and wherein the second aperture is configured to receive a tool to facilitate removing the arbor body from the saw blade.

12. The saw blade of claim 11, wherein a pivot axis extends through a center of the central bore, and wherein the first aperture and the second aperture are positioned on opposite sides of the pivot axis.

13. The saw blade of claim 12, wherein the arbor is mirror-symmetric about the pivot axis.

14. The saw blade of claim 10, wherein the arbor body is diamond shaped.

15. The saw blade of claim 10, wherein a perimeter of the arbor is partially defined by etchings that extend from the aperture.

16. A method of removing an arbor from a saw blade, the arbor including an arbor body, a central bore formed through the arbor body, and an aperture formed through the arbor body and separate from the central bore, the method comprising:
inserting a tool into the aperture;
pivoting the tool inside the aperture to at least partially separate the arbor body from the saw blade;
lifting the tool away from the saw blade to at least partially separate the arbor body from the saw blade; and
removing the arbor body from the saw blade after the arbor body is sufficiently separated.

17. The method of claim 16, further comprising further inserting the tool shaft into the aperture after pivoting the tool inside the aperture.

18. The method of claim 16, further comprising applying an alternating lifting force and downward force to the tool until the arbor body separates from the saw blade.

19. The method of claim 16, wherein the central bore is circular, wherein the arbor body is diamond shaped, and wherein removing the arbor body from the saw blade includes leaving a diamond shaped opening in the saw blade.

20. The method of claim 16, wherein inserting the tool includes inserting a head of a screwdriver into the aperture.
